(19) United States
(12) Patent Application Publication
(10) Pub. No.: US 2008/0286473 A1
(43) Pub. Date: Nov. 20, 2008

(54) Ice Adhesion Mitigation

(75) Inventors: Trent M. Smith, Melbourne, FL (US); Erik S. Weiser, Yorktown, VA (US); Roberto J. Cano, Yorktown, VA (US); Michael E. Prince, Union Grove, AL (US); Leslie A. Curtis, Huntsville, AL (US); Charles D. DeWeese, Steele, AL (US)

Correspondence Address: NASA JOHN F. KENNEDY SPACE CENTER, MAIL CODE: CC-A/OFFICE OF CHIEF COUNSEL, ATTN: PATENT COUNSEL, KENNEDY SPACE CENTER, FL, 32899, US

(73) Assignees: United States of America as Represented by the Administrator of the National Aeronautics; and space Ad+, Washington, DC (US)

(21) Appl. No.: 11/750,761

(22) Filed: May 18, 2007

(51) Int. Cl. B32B 33/00; B05D 3/12

(52) U.S. Cl. 427/368; 427/427.4; 428/327; 428/447; 524/261

(57) ABSTRACT

Hydrophobic coating compositions containing siloxanes and fluoropolymer resin hinder the accumulation of moisture and reduce the adhesion of ice formed on the coating. Applications of such coating compositions to surfaces thus reduce the propensity for ice formation on a treated surface, and ease the dislodging of any ice formed on the treated surface.

### ORIGIN OF INVENTION

The invention described herein was made by employees of the United States Government and may be manufactured and used by or for the Government of the United States of America for governmental purposes without the payment of any royalties thereon or therefor.

### TECHNICAL FIELD OF THE INVENTION

The present invention relates generally to ice adhesion mitigation and, in particular, to the reduction of ice adhesion through the use of hydrophobic coatings containing siloxanes and fluoropolymer resins.

### BACKGROUND OF THE INVENTION

Ice adhesion is undesirable in a variety of situations. Ice formation on aircraft wings can detrimentally alter their aerodynamic properties. Ice formation on ships sailing in sub-freezing conditions can affect their seaworthiness. In fact, ice formation on a variety of industrial and exterior equipment, such as locks, valves, gauges, etc. can hinder their use or performance.

Ice adhesion is also a key concern in the NASA Space Shuttle program. The Space Shuttles utilize solid rocket boosters and an external fuel tank during launch. The external fuel tank delivers 535,000 gallons of liquid hydrogen and oxygen propellants to the three Space Shuttle Main Engines (SSME). The tank, the only component that cannot be reused, is covered by polyisocyanurate and polyurethane foam materials that insulate the propellants, in part, to help keep ice from forming on the tank's exterior. However, there are areas of the tank that form ice and the formed ice can be a source of debris and hazard of flight. The umbilical structures that currently feed LO₂ and LH₂ to the SSMEs often ice up wherein a nominal 50% portion or less of such ice build-up is actually liberated at Solid Rocket Booster (SRB) start up. Use of a coating formed in accordance with the present invention should significantly increase the amount of ice liberated prior to flight, directly improving flight safety.

For the reasons stated above, and for other reasons that will become apparent to those skilled in the art upon reading and understanding the present specification, there is a current need in the art for successful approaches to mitigating ice adhesion.

### SUMMARY OF THE INVENTION

The various embodiments employ a hydrophobic coating containing siloxanes and fluoropolymers to hinder the accumulation of moisture and to reduce the adhesion of any ice formed onto a coated surface or substrate. The invention includes methods and compositions of varying scope.

### BRIEF DESCRIPTION OF THE DRAWINGS

FIG. 1 shows an example of a coupon encased in ice within an aluminum holder for use in testing the various embodiments of the invention.

FIG. 2A depicts a coupon coated with a composition in accordance with one embodiment of the invention.

FIG. 2B depicts a coupon coated with a composition in accordance with another embodiment of the invention.

FIG. 3A depicts load-time response of an example control coupon for comparison to embodiments of the invention.

FIG. 3B depicts load-displacement response of an example control coupon for comparison to embodiments of the invention.

FIGS. 4A and 4B depict representative load-time results for two testing groups in a first cycle of testing.

FIGS. 5A and 5B depict representative load-time results for two testing groups in a second cycle of testing.

FIGS. 6A and 6B depict representative load-time results for two testing groups in a third cycle of testing.

FIGS. 7A and 7B depict peak load and total work results for the representative samples generating FIGS. 6A and 6B over three cycles of testing.

FIG. 8A depicts an example of a contact angle of a water droplet on a control coupon.

FIG. 8B depicts an example of a contact angle of a water droplet on a coupon having a coating in accordance with an embodiment of the invention.

FIG. 9 depicts a double conical specimen with a layer of ice at the center.

FIG. 10 is a graph illustrating tensile results of SILC-I on various foams

### DETAILED DESCRIPTION OF THE INVENTION

In the following detailed description of the preferred embodiments, reference is made to the accompanying drawings that form a part hereof, and in which is shown by way of illustration specific preferred embodiments in which the present invention may be practiced. These embodiments are described in sufficient detail to enable those skilled in the art to practice the invention, and it is to be understood that other embodiments may be utilized and that process and chemical changes may be made without departing from the spirit and scope of the present invention. It is noted that the drawings are not to scale unless a scale is provided thereon. The following detailed description is, therefore, not to be taken in a limiting sense, and the scope of the present invention is defined only by the appended claims and equivalents thereof.

Umbilical structures which feed the Space Shuttle Main Engines LO2 and LH2 from the external fuel tank of NASA's Space Shuttle are known locations of frost and ice growth during the pre-launch period following fuel loading. At Solid Rocket Booster (SRB) start, a nominal 50% portion or less of the ice build up is released due to the vibro-acoustic energy created during the launch sequence. If most or all of the ice was released at SRB start then little or no ice would be available to adversely impact Shuttle tiles. New physics-based models indicate that ice debris from the umbilical structure is a serious flight hazard which may well be mitigated if ice release occurs before flight or very early in flight. Such early ice release can be achieved by appropriate application of the present invention's unique coating which can reduce ice adhesion by as much as 90%.

The various embodiments of the present invention employ a hydrophobic coating containing siloxanes and fluoropolymers to hinder the accumulation of moisture and to reduce the adhesion of any ice formed on the coating. By using a hydrophobic coating formed in accordance with the present invention, moisture can bead off the surface before it has an opportunity to freeze. And by reducing adhesion, any formation of ice ultimately may be dislodged with less force. One preferred embodiment of the present invention hereafter referred to as the Shuttle Ice Liberation Coating I (SILC-I) comprises a dilute solution of siloxanes in acidified alcohol and fluoropolymer powder. In another preferred embodiment of the present invention, hereinafter referred to as the Shuttle Ice Liberation Coating II (SILC-II) comprises the same major ingredients as SILC-I with the addition of an ultra-violet light absorbing chemical.

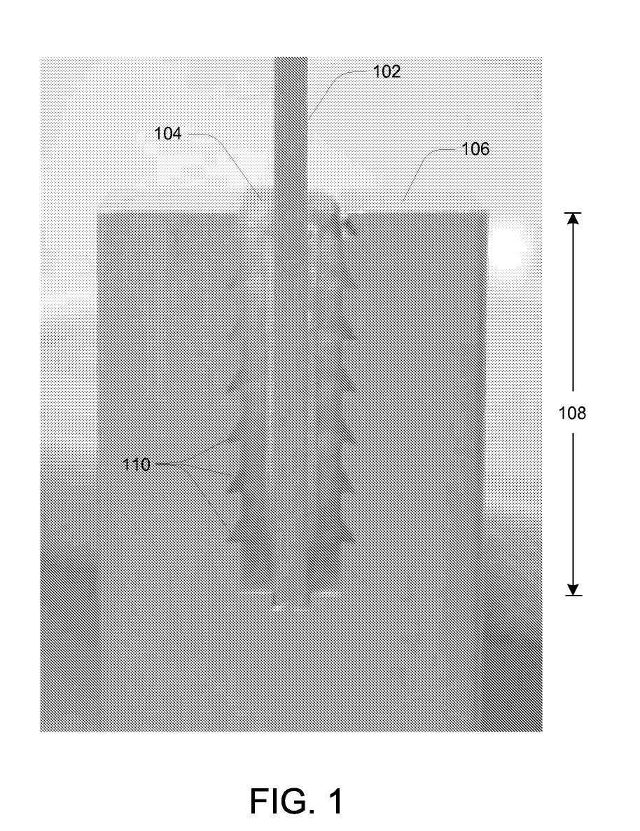

Embodiments of the invention were tested against uncoated surfaces using a double lap shear testing protocol (ASTM [2002] D3528-96). In this protocol, a single coupon was encased on two sides by ice 0.125 in. (0.317 cm) thick. FIG. 1 shows an example of a coupon 102 encased in ice 104 within an aluminum holder 106. Roughness elements 110 were used to limit shearing of the ice 104 at the surface of holder 106. Although the roughness elements 110 are shown in FIG. 1 to be downward slanting, upward slanting roughness elements were used in much of the testing. The coupons 102 used during evaluation were aluminum surfaced with a KOROPON primer, an epoxy topcoat available from PRC-DeSoto International, Inc., Glendale, Calif. While data generation focused on KOROPON-surfaced coupons, the invention is not limited to use on such a surface composition.

As the coatings were originally designed for use with the External Tank LO₂ feed line brackets, double lap shear tests were performed at the hardware operating temperatures. Bracket temperatures obtained by NASA were used to design the temperature regime for testing of various embodiments of the present invention. In the various embodiments, compositions containing siloxanes and fluoropolymer resin particles in solvent were prepared. The source of the siloxanes for testing was RAIN-X Original Glass Treatment available from SOPUS Products, Houston, Tex. The composition of the RAIN-X solution, according to the MSDS, is as follows: ethanol/SD alcohol 40 86%; isopropanol 4%; ethyl sulfate 1%; polydimethylsiloxanes (silicone oil) <9%; silicic acid (H4SiO4), tetraethyl ester, hydrolysis products with chlorotrimethylsilane <9%; and siloxanes and silicones, di-Me, hydroxy-terminated <9%. More generally, such a solution can be thought of as essentially a dilute solution, i.e., approximately 5%, of poly alkyl hydrogen siloxanes in an acidified alcohol carrier for the purposes described herein. Composition percentages are in weight percent unless otherwise noted. The compositions of the various embodiments may contain additional chemical components that do not materially affect the basic and novel properties of the compositions disclosed herein. Some examples include dyes, stabilizers, preservatives, and antimicrobial agents.

Sources for the fluoropolymer resin particles may include polytetrafluoroethylene (PTFE) powders or other fluorinated polymer powders. UF-8TA is a functional ultra-fine PTFE powder with an average agglomerated particle size of 4.0 μm, average particle size of 0.3 μm, and component particle sizes as small as 200 nm (0.2 μm). The density of UF-8TA is 450 g/L. It is specially treated for compatibility and made for release applications where superior dispersion is needed. Improved properties over standard PTFE include extremely good release, chemical inertness to all industrial chemicals and solvents, wide range of service temperatures from −240 to 250° C. (−400 to 482° F.), low friction, and excellent non-stick properties. In comparison, MP-55 is a white, fine particle PTFE micro-powder with an average particle size of 4.0 μm, minimum particle size of 0.2 μm, and density of 300 g/L. It is used as an additive in several applications, including dry film lubricants and coatings. As used with various embodiments of the invention, the MP-55 PTFE powder produces performance levels significantly improved over similar compositions having UF-8TA PTFE powder. Both materials are available through Laurel Products, LLC, Elverson, Penn.

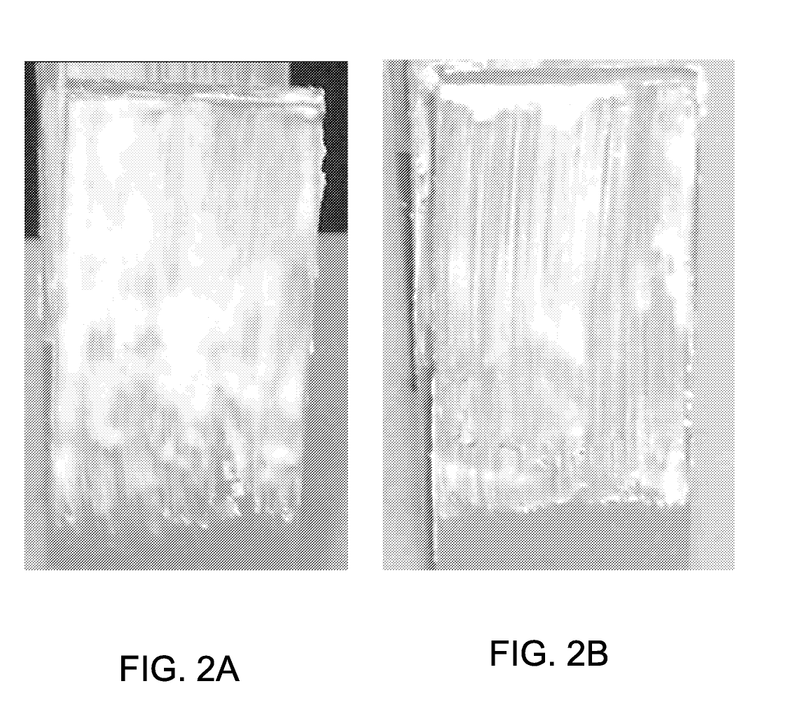

FIG. 2A depicts a coupon coated with a composition containing approximately 50% RAIN-X solution and approximately 50% MP-55 PTFE powder. FIG. 2B depicts a coupon coated with a composition containing approximately 60% RAIN-X solution and approximately 40% MP-55 PTFE powder.

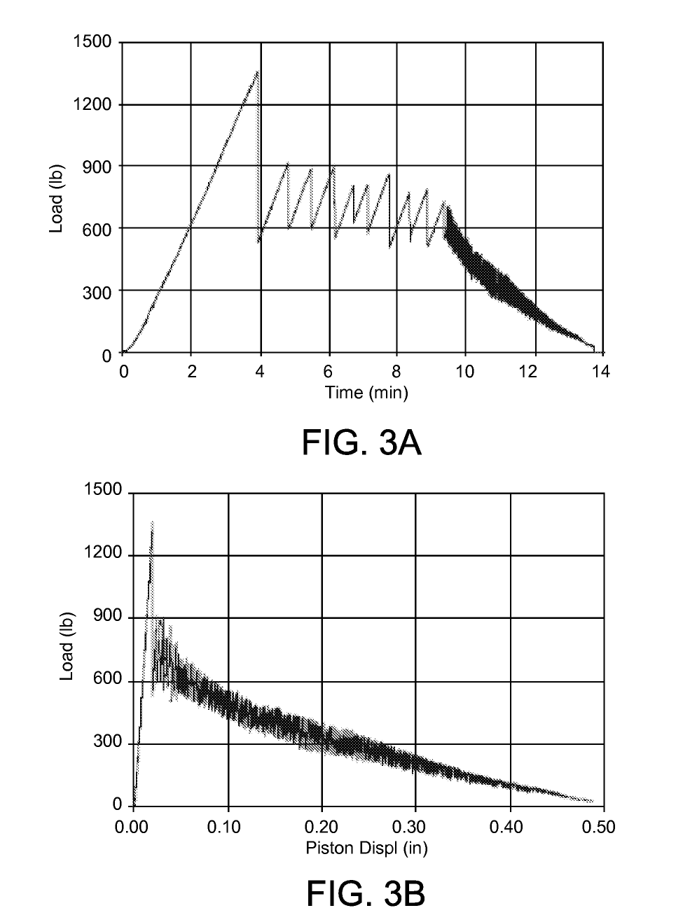

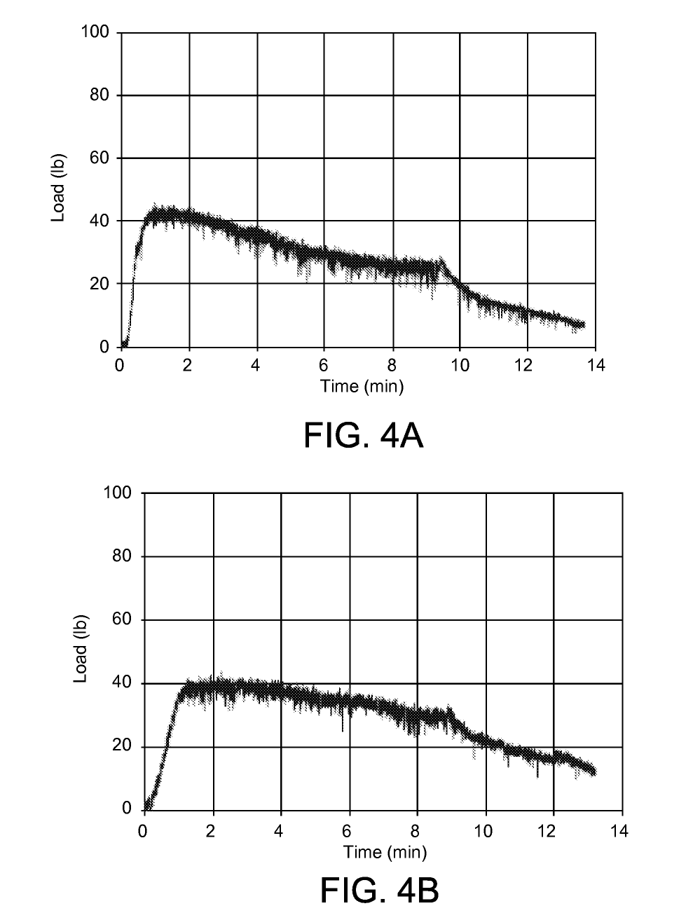

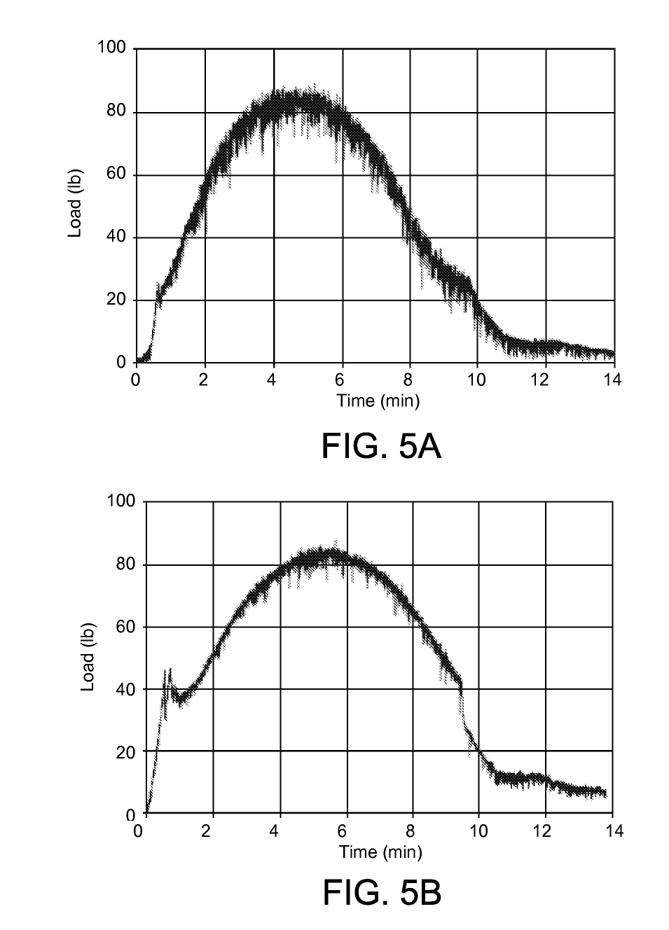

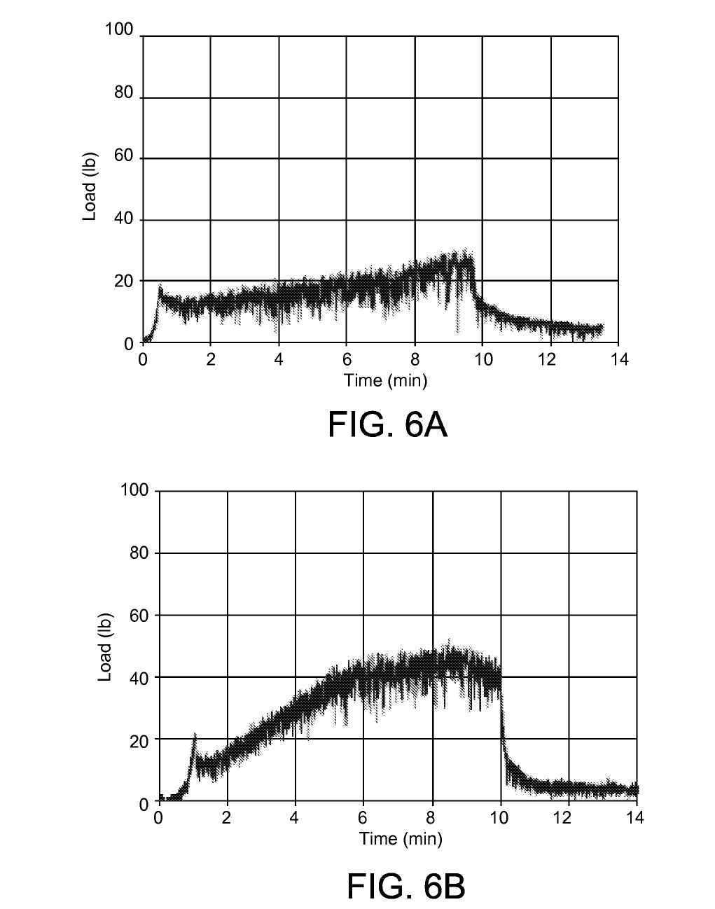

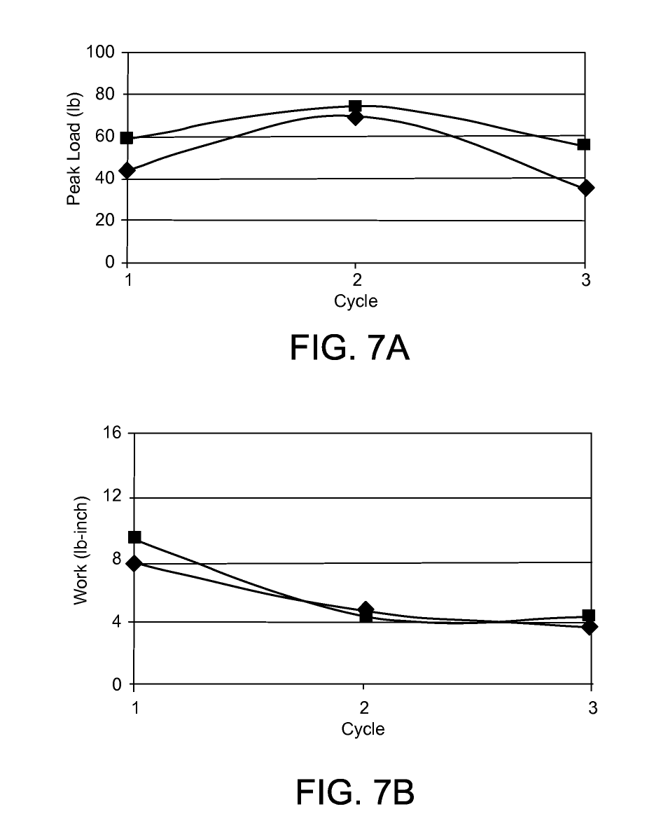

Testing of coated coupons of the type depicted in FIGS. 2A and 2B were compared to control tests of uncoated coupons. The control tests were characterized by a series of audible ice fractures. The load typically increased linearly with time until a primary ice fracture occurred, greatly reducing the load. Subsequent linear load increases would be followed by subsequent fractures and sharply reduced load, producing a periodic “saw-tooth” pattern. The load-time and load-displacement responses of a particularly strong control is provided in FIGS. 3A and 3B, respectively.

Testing of compositions in accordance with embodiments of the present invention included several variations on formulations and coated substrates. The following examples show the dramatically reduced ice adhesion results for samples of various weight percent compositions tested once, then again a second and third time without reapplying the coating. The repeated ice tests demonstrate the durability of the coating systems. In creating and testing the various samples, the following procedural steps were followed for both SILC-I and SILC-II test samples:
Clean surface, i.e., area to be coated can be cleaned with isopropyl alcohol (IPA) prior to application,
Add appropriate amount of dilute solution of siloxanes in acidified alcohol into mixing apparatus,
Add appropriate fluorinated polymer powder into mixing apparatus containing RAIN-X,
Rapidly mix components, while avoiding overmixing, until powder is visibly wet out;
Add UV absorbing chemical if desired;
Apply mixture to surface within approximately 20 minutes of mixing to prevent viscosity changes due to solvent evaporation (otherwise mixture should be maintained in tightly closed container for period not to exceed 5 days);
Apply mixture with foam brush;
Create coating of approximately 0.02 g/cm² thickness;
Create even, thin, and smooth coating;
Allow coating to cure for minimum of 3 hours prior to handling and 24 hours prior to use; and
Brush or buff off excess material if desired.

### EXAMPLE 1

KOROPON primed aluminum coupons with dimensions of 2.00 inches (5.08 cm)×1.0 inch (2.54 cm) were wiped clean with an isopropyl alcohol (IPA) solution prior to application of the coating. 5 grams of original RAIN-X was weighed into a mixing container. To the RAIN-X was added 5 grams of Laurel Products MP-55 PTFE powder. The contents of the container were rapidly mixed for approximately 30 seconds or until the powder was visibly wet out. Extra care was taken to ensure that the contents of the container were not over mixed. The mixture was then applied to the surface of the KOROPON primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wavenumber. The KOROPON primed aluminum coated with the SILC coating was placed into a holder where ice was allowed to grow, see FIG. 1. The ice thickness was approximately 0.125 inches (0.318 cm) on each side of the KOROPON coated sample. Double lap shear testing was performed which resulted in an peak shear load of 37±9 lbs and a total work of 7.3±1.1 lbs-in as compared to the uncoated KOROPON which had a peak shear load of 642±164 lbs and a total work of 122±12 lbs-in. Tables 1-3 and 8 herebelow show the resultant peak load for four different compositions of the SILC coating containing original RAIN-X and MP-55 PTFE Teflon.

### EXAMPLE 2

KOROPON primed aluminum coupons with dimensions of 2.00 inches (5.08 cm)×1.0 inch (2.54 cm) were wiped clean with an isopropyl alcohol (IPA) solution prior to application of the coating. 4.3 grams of original RAIN-X was weighed into a mixing container. To the RAIN-X was added 5.7 grams of UF-8TA functional ultra-fine PTFE powder. The contents of the container were rapidly mixed for approximately 30 seconds or until the powder was visibly wet out. Extra care was taken to ensure that the contents of the container were not over mixed. The mixture was then applied to the surface of the KOROPON primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wavenumber. The KOROPON primed aluminum coated with the SILC coating was placed into a holder where ice was allowed to grow, see FIG. 1. The ice thickness was approximately 0.125 inches (0.318 cm) on each side of the KOROPON coated sample. Double lap shear testing was performed which resulted in an peak shear load of 788±133 lbs and a total work of 104±12.0 lbs-in as compared to the uncoated KOROPON which had a peak shear load of 642±164 lbs and a total work of 122±12.0 lbs-in. Table 1 herebelow shows the resultant peak load and total work for two different compositions of the SILC coating containing original RAIN-X and UF-8TA ultra-fine PTFE Teflon.

### EXAMPLE 3

KOROPON primed aluminum coupons with dimensions of 2.00 inches (5.08 cm)×1.0 inch (2.54 cm) were wiped clean with an isopropyl alcohol (IPA) solution prior to application of the coating. 5.0 grams of original RAIN-X was weighed into a mixing container. To the RAIN-X was added 3.0 grams of Laurel Products MP-55 PTFE powder and 2.0 grams of UF-8TA functional ultra-fine PTFE powder. The contents of the container were rapidly mixed for approximately 30 seconds or until the powder was visibly wet out. Extra care was taken to ensure that the contents of the container were not over mixed. The mixture was then applied to the surface of the KOROPON primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wavenumber. The KOROPON primed aluminum coated with the SILC coating was placed into a holder where ice was allowed to grow, see FIG. 1. The ice thickness was approximately 0.125 inches (0.318 cm) on each side of the KOROPON coated sample. Double lap shear testing was performed which resulted in an peak shear load of 74±19 lbs and a total work of 14.4±4.7 lbs-in as compared to the uncoated KOROPON which had a peak shear load of 642±164 lbs and a total work of 122±12.0 lbs-in. Tables 1-3 shows the resultant peak load and total work for the SILC coating containing original RAIN-X, MP-55 PTFE Teflon and UF-8TA ultra-fine PTFE Teflon.

TABLE 1
Double lap shear peak load results of various RAIN-X/fluorinated
polymer coatings.

| | cycle 1 | | | |
|---|---|---|---|---|
| | RAIN-X | | peak | stddev |
| cycle 1 | (wt %) | PTFE (wt %) | load (lbs) | (lbs) |
| Koropon Control | 0 | 0 | 642 | 164 |
| RAIN-X/MP-55 50:50 | 50 | 50 | 37 | 9 |
| RAIN-X/MP-55 60:40 | 60 | 40 | 38 | 7 |
| RAIN-X/MP-55 70:30 | 70 | 30 | 48 | 22 |
| RAIN-X/MP-55 80:20 | 80 | 20 | 69 | 24 |
| RAIN-X/MP-55/UF-8TA | 50 | 30:20 | 74 | 19 |
| 50:30:20 | | | | |
| RAIN-X/UF-8TA 43:57 | 43 | 57 | 788 | 138 |
| RAIN-X/UF-8TA 50:50 | 50 | 50 | 688 | 105 |

TABLE 2
Double lap shear peak load results for various RAIN-X/fluorinated
polymer coatings tested twice without reapplying the coating.

| | cycle 2 | | | |
|---|---|---|---|---|
| | RAIN-X | | peak | stddev |
| cycle 2 | (wt %) | PTFE (wt %) | load (lbs) | (lbs) |
| Koropon Control | 0 | 0 | — | — |
| RAIN-X/MP-55 50:50 | 50 | 50 | 45 | 21 |
| RAIN-X/MP-55 60:40 | 60 | 40 | 22 | 10 |
| RAIN-X/MP-55 70:30 | 70 | 30 | 49 | 22 |
| RAIN-X/MP-55 80:20 | 80 | 20 | 35 | 11 |
| RAIN-X/MP-55/UF-8TA | 50 | 30:20 | 64 | 20 |
| 50:30:20 | | | | |
| RAIN-X/UF-8TA 43:57 | 43 | 57 | — | — |
| RAIN-X/UF-8TA 50:50 | 50 | 50 | — | — |

TABLE 3
Double lap shear peak load results for various RAIN-X/fluorinated
polymer coatings tested a total of three times without reapplying
the coating.

| | cycle 3 | | | |
|---|---|---|---|---|
| | RAIN-X | | peak | stddev |
| cycle 3 | (wt %) | PTFE (wt %) | load (lbs) | (lbs) |
| Koropon Control | 0 | 0 | — | — |
| RAIN-X/MP-55 50:50 | 50 | 50 | 49 | 25 |
| RAIN-X/MP-55 60:40 | 60 | 40 | 21 | 8 |
| RAIN-X/MP-55 70:30 | 70 | 30 | 39 | 13 |
| RAIN-X/MP-55 80:20 | 80 | 20 | 33 | 8 |
| RAIN-X/MP-55/UF-8TA | 50 | 30:20 | 53 | 31 |
| 50:30:20 | | | | |
| RAIN-X/UF-8TA 43:57 | 43 | 57 | — | — |
| RAIN-X/UF-8TA 50:50 | 50 | 50 | — | — |

TABLE 4
Coating mixtures by weight.

| | | Target % | | |
|---|---|---|---|---|
| Formulation | Component | by wt. (g) | Target wt. (g) | Actual wt. (g) |
| 100-0 | RAIN-X | 51.5 | 25.75 | 25.77 |
| | DF 1040 | 0.0 | 0.0 | 0.0 |
| | MP-55 | 48.5 | 24.25 | 24.24 |
| 97.5-2.5 | RAIN-X | 40.0 | 24.5 | 24.5 |
| | DF 1040 | 2.5 | 1.25 | 1.24 |
| | MP-55 | 48.5 | 24.25 | 24.23 |
| 95-5 | RAIN-X | 46.5 | 23.25 | 23.28 |
| | DF 1040 | 5.0 | 2.5 | 2.5 |
| | MP-55 | 48.5 | 24.25 | 24.26 |
| 90-10 | RAIN-X | 41.5 | 20.75 | 20.80 |
| | DF 1040 | 10.0 | 5.0 | 5.1 |
| | MP-55 | 48.5 | 24.25 | 24.27 |

### EXAMPLE 4

KOROPON primed aluminum coupons with dimensions of 2.00 inches (5.08 cm)×1.0 inch (2.54 cm) were wiped clean with an isopropyl alcohol (IPA) solution and dip coated with organosilicate-organotitanate primer, DC-1200 and allowed to dry prior to application of the coating. 20.80 grams of original RAIN-X was weighed into a mixing container. To the RAIN-X was added 5.1 grams of a polymethyl hydrosiloxane fluid, DF 1040, which was mixed with a spatula for 100 strokes. To the mixture was added 24.27 grams of Laurel Products MP-55 PTFE powder. The contents of the container were mixed for 300 strokes then transferred to a mortar and mixed with a pestle for 300 additional strokes. The mixture was then transferred to a seal container prior to application to the KOROPON/DC-1200 primed surface. The mixture was then applied to the surface of the KOROPON/DC-1200 primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wave number. The KOROPON / DC-1200 primed aluminum coated with the SILC+DF1040 coating was placed into a holder where ice was allowed to grow, see FIG. 1. The ice thickness was approximately 0.125 inches (0.318 cm) on each side of the KOROPON/DC-1200 coated sample. Double lap shear testing was performed which resulted in an peak shear load of 96±12 lbs and a total work of 32±6.0 lbs-in as compared to the uncoated KOROPON which had a peak shear load of 642±164 lbs and a total work of 122±12.0 lbs-in. Table 4 above shows other compositions of RAIN-X, DF-1040, and MP-55 PTFE Teflon that were synthesized. Table 5 shows the resultant peak load and total work for two different compositions of the SILC coating containing original RAIN-X, DF-1040, and MP-55 PTFE Teflon.

TABLE 5
Comparison of Phase 2 durability results.

| | | Total work | Work | Peak load | |
|---|---|---|---|---|---|
| Formulation | | mean ± s.d. | range | mean ± s.d. | Peak load |
| (% DF1040) | Cycle | (lb-in.) | (lb-in.) | (lb) | range (lb) |
| 10 | 1 | 32 ± 6 | 24-41 | 96 ± 12 | 85-119 |
| | 2 | 33 ± 16 | 17-64 | 152 ± 36 | 92-190 |
| | 3 | 19 ± 16 | 4-49 | 92 ± 43 | 22-135 |
| 5 | 1 | 42 ± 10 | 30-56 | 124 ± 32 | 71-164 |
| | 2 | 35 ± 5 | 29-41 | 128 ± 25 | 102-174 |
| | 3 | 23 ± 5 | 16-29 | 80 ± 17 | 56-103 |
| 0 | 1 | 41 ± 7 | 33-50 | 139 ± 20 | 102-160 |
| | 2 | 23 ± 11 | 6-37 | 88 ± 33 | 34-123 |
| | 3 | 23 ± 5 | 7-28 | 58 ± 23 | 31-87 |

### EXAMPLE 5

KOROPON primed aluminum coupons with dimensions of 2.00 inches (5.08 cm)×1.0 inch (2.54 cm) were wiped clean with an isopropyl alcohol (IPA) solution prior to application of the coating. 5.5 grams of original RAIN-X was weighed into a mixing container. To the RAIN-X was added 3.7 grams of Laurel Products MP-55 PTFE powder. The contents of the container were rapidly mixed for approximately 30 seconds or until the powder was visibly wet out. To the mixture was added 0.8 grams of Tinuvin 400, UV absorber, and mixture thoroughly. Extra care was taken to ensure that the contents of the container were not over mixed. The mixture was then applied to the surface of the KOROPON primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wavenumber. The KOROPON primed aluminum coated with the SILC coating was placed into a holder where ice was allowed to grow, see FIG. 1. The ice thickness was approximately 0.125 inches (0.318 cm) on each side of the KOROPON coated sample. Double lap shear testing was performed which resulted in an peak shear load of 153±64 lbs and a total work of 14.2±3.6 lbs-in as compared to the uncoated KOROPON which had a peak shear load of 765±205 lbs and a total work of 182±90.3 lbs-in. Tables 6-8 herebelow show the resultant peak load and total work for two different compositions of the SILC coating containing original RAIN-X, Tinuvin 400 and MP-55 PTFE Teflon.

### EXAMPLE 6

KOROPON primed aluminum coupons with dimensions of 2.00 inches (5.08 cm)×1.0 inch (2.54 cm) were wiped clean with an isopropyl alcohol (IPA) solution and then coated with a thin layer of FIRE-X paint and allowed to dry prior to application of the coating. 6.0 grams of original RAIN-X was weighed into a mixing container. To the RAIN-X was added 4.0 grams of Laurel Products MP-55 PTFE powder. The contents of the container were rapidly mixed for approximately 30 seconds or until the powder was visibly wet out. Extra care was taken to ensure that the contents of the container were not over mixed. The mixture was then applied to the surface of the KOROPON/FIRE-X primed aluminum coupon with a foam brush. A thin even coating was accomplished by first applying ample amount of the mixture to both sides of the foam brush and then with one side of the foam brush apply one stoke up, flip the brush to utilize the other side and apply another stroke up. This process is repeated for all surfaces to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wavenumber. The KOROPON/FIRE-X primed aluminum coated with the SILC coating was placed into a holder where ice was allowed to grow, see FIG. 1. The ice thickness was approximately 0.125 inches (0.318 cm) on each side of the KOROPON/FIRE-X coated sample. Double lap shear testing was performed which resulted in an peak shear load of 90±43 lbs and a total work of 18.3±6.3 lbs-in as compared to the uncoated KOROPON/FIRE-X sample which had a peak shear load of 1415±89 lbs and a total work of 170±20 lbs-in. Tables 6 and 7 show the resultant peak load and total work for the SILC coating containing original RAIN-X and MP-55 PTFE Teflon on Kapton film, Kapton Tape, and FIRE-X paint. In all cases, the adhesion of the ice to the different substrates was reduced as compared to the uncoated surface.

TABLE 6
Double lap shear test results for various icephobic coating compositions on varied substrates.
Application to varied substrates demonstrates the effectiveness of the composition to bond
in and reduce ice adhesion.

| | | | | cycle 1 | |
|---|---|---|---|---|---|
| | RAIN-X | PTFE | Tinuvin 400 | peak load | stddev |
| cycle 1 | (wt %) | (wt %) | (wt %) | (lbs) | (lbs) |
| Koropon Control | 0 | 0 | 0 | 765 | 205 |
| RAIN-X/MP-55 60:40 on Koropon | 60 | 40 | 0 | 79 | 30 |
| RAIN-X/MP-55/Tinuvin 400 55:37:8 | 55 | 37 | 8 | 153 | 64 |
| on Koropon | | | | | |
| RAIN-X/MP-55/Tinuvin 400 58:38:4 | 58 | 38 | 4 | 133 | 77 |
| on Koropon | | | | | |
| Kapton Tape Control* | 0 | 0 | 0 | 284 | 104 |
| RAIN-X/MP-55 60:40 on Kapton Tape | 60 | 40 | 0 | 52 | 24 |
| Kapton Film Control | 0 | 0 | 0 | 663 | 108 |
| RAIN-X/MP-55 60:40 on Kapton Film | 60 | 40 | 0 | 120 | 20 |
| FIRE-X Paint Control | 0 | 0 | 0 | 1415 | 89 |
| RAIN-X/MP-55 60:40 on FIRE-X Paint | 60 | 40 | 0 | 90 | 43 |

*Kapton Tape ripped and failed adhesively to the Koropon coated test specimen (not the ice) causing an artificially low control specimen peak load.

TABLE 7
Double lap shear test results for various icephobic coating compositions on varied substrates.
Application to varied substrates demonstrates the effectiveness of the composition to bond
in and reduce ice adhesion. This is the second cycle thus demonstrating overall durability.

| | | | | cycle 2 | |
|---|---|---|---|---|---|
| | RAIN-X | PTFE | Tinuvin 400 | peak load | stddev |
| cycle 2 | (wt %) | (wt %) | (wt %) | (lbs) | (lbs) |
| Koropon Control | 0 | 0 | 0 | — | — |
| RAIN-X/MP-55 60:40 on Koropon | 60 | 40 | 0 | 95 | 41 |
| RAIN-X/MP-55/Tinuvin 400 55:37:8 | 55 | 37 | 8 | 68 | 20 |
| on Koropon | | | | | |
| RAIN-X/MP-55/Tinuvin 400 58:38:4 | 58 | 38 | 4 | 65 | 15 |
| on Koropon | | | | | |
| Kapton Tape Control* | 0 | 0 | 0 | — | — |
| RAIN-X/MP-55 60:40 on Kapton Tape | 60 | 40 | 0 | 34 | 10 |
| Kapton Film Control | 0 | 0 | 0 | — | — |
| RAIN-X/MP-55 60:40 on Kapton Film | 60 | 40 | 0 | 135 | 29 |
| FIRE-X Paint Control | 0 | 0 | 0 | — | — |
| RAIN-X/MP-55 60:40 on FIRE-X Paint | 60 | 40 | 0 | 64 | 24 |

TABLE 8
Double lap shear test results for two icephobic coatings through
five cycles.

| | | RAIN-X/ | RAIN-X/ | RAIN-X/MP-55/ |
|---|---|---|---|---|
| | | MP-55 | MP-55 | Tinuvin 400 |
| | Koropon | 60:40 on | 60:40 on | 55:37:8 on |
| | Control | Koropon | Koropon | Koropon |
| Cycle 1 | | | | |
| Peak load (lbs) | 765 | 38 | 79 | 153 |
| Stddey (lbs) | 205 | 7 | 30 | 64 |
| Cycle 2 | | | | |
| Peak load (lbs) | — | 25 | 95 | 68 |
| Stddey (lbs) | — | 8 | 41 | 20 |
| Cycle 3 | | | | |
| Peak load (lbs) | — | 21 | 58 | 54 |
| Stddey (lbs) | — | 8 | 24 | 17 |
| Cycle 4 | | | | |
| Peak load (lbs) | — | 27 | 75 | 62 |
| Stddey (lbs) | — | 9 | 26 | 21 |
| Cycle 5 | | | | |
| Peak load (lbs) | — | 17 | — | — |
| Stddey (lbs) | — | 5 | — | — |

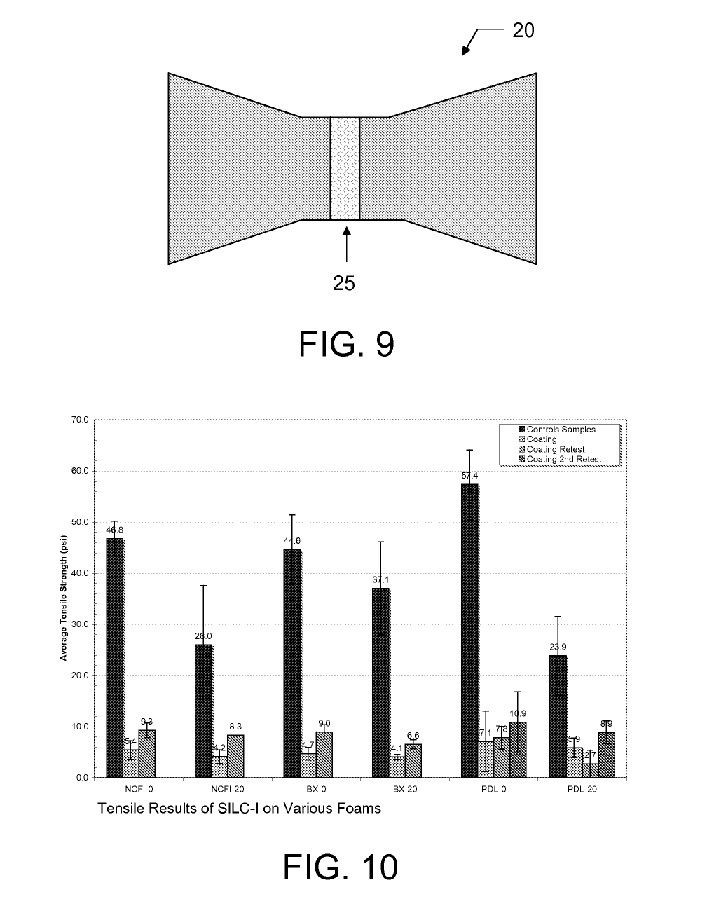

Various foams were machined for testing with the ASTM D1623 ‘Type A’ double-conical specimen 20 as shown in FIG. 9 with a 0.25-inch layer of ice 25 grown in situ in the center of the specimen's gage section. The test area of these foam test specimens were wiped clean with an isopropyl alcohol (IPA) solution prior to application of the coating. 6 grams of original RAIN-X was weighed into a mixing container. To the RAIN-X was added 4 grams of Laurel Products MP-55 PTFE powder. The contents of the container were rapidly mixed for approximately 30 seconds or until the powder was visibly wet out. Extra care was taken to ensure that the contents of the container were not over mixed. The coating was applied to only one interface of a sectioned double-conical specimen. A thin even coating was accomplished by first applying ample amount of the mixture to a gloved finger and then wiped onto the foam test area. This process is repeated for each set of foam specimens to be coated. The resultant wet coating should be about 0.02 g/cm². The preferable coating should appear even, thin, and smooth. The coating was allowed to cure for a minimum of 3 hours prior to handling and 24 hours prior to use. Cure time was determined by use of Fourier Transform Infrared Spectroscopy (FTIR), which shows no peak change after 24 hours at the 1220 cm⁻¹ wave number. The foam specimens 20 of FIG. 9 treated with the SILC coating were placed into a holder where hard ice was grown between the coated foam surface and the other cleaned foam. The ice thickness 25 was approximately 0.250 inches (0.64 cm) in the specimen gage section. Double-conical tensile testing was performed on BX-265, NCFI 24-124, and PDL1034 at 0° F. and 20° F. Specimens were thawed, ice was re-grown, and then retested without reapplication of the SILC. FIG. 10 presents the results of several foam types. In all cases, the adhesion of the ice to the different substrates was reduced as compared to the uncoated surface.

X-ray photoelectron spectroscopy (XPS) also called electron spectroscopy for chemical analysis (ESCA) is a chemical surface analysis method. XPS measures the chemical composition of the outermost 100 Å of a sample. Measurements can be made at greater depths by ion sputter etching to remove surface layers. All elements except for H and He can be detected at concentrations above 0.05 to 1.0 atom %, depending on the element. In addition, chemical bonding information can be determined from detailed analysis. XPS measurement of fluorocarbon, a principal component of compositions of the various embodiments, remaining on the surface of SILC-I coupons following three cycles of double lap shear testing were compared to similar measurements of a coated, but untested, SILC-I coupon. The cycled coupon surfaces contained less MP-55 than that of the untested coupon, indicating a loss of some of the coating. However, a significant amount of coating remained on the surfaces, and the ice adhesion performance had not been compromised. Consistent with the observed loss of coating at each test cycle, these results suggest that the failure plane between the tested coupons and the ice occurred within the coating. Areas where coating was not visible by eye, XPS measured significant amounts of SILC-I and SILC-II to be present.

Ten droplets of deionized water were placed along the length of each of these same coupons for contact angle analysis. Mean angle±standard deviation obtained for a KOROPON-surface control coupon was 81°±3.3°, increasing to 104°±1.8° for a KOROPON-surface control coupon with RAIN-X coating. In contrast, the tested RM samples (Table 9) were 137°±6.6°, 142°±8.2°, and 137°±11.9°, respectively, and the untested RM sample was 143°±10.9°. It is noted that the contact angle of PTFE is approximately 112°, thus leading to the unexpected result that the contact angle of compositions in accordance with embodiments of the invention combining siloxanes and fluoropolymer resin exceeds the contact angles of each constituent of the composition.

Table 9 herebelow provides contact angle data of various icephobic formulations showing surface energy interactions with water. Coating formulations are made by weight percent addition of constituent materials as described in listed examples (i.e. RAIN-X/MP-55/Tinuvin 400 55-37-8 is 55% by weight RAIN-X, 37% by weight MP-55 PTFE powder, and 8% by weight Tinuvin 400 UV absorber). The data shows the resulting coatings to be super-hydrophobic and durable after weathering in the Kennedy Space Center launch pad environment.

TABLE 9

| | | 0 days | | 30 days | |
|---|---|---|---|---|---|
| Sample | | Average | 0 days | Average | 30 days |
| AI coupons | Description | (°) | SD (°) | (°) | SD (°) |
| Control 1 | KOROPON control | 80.9 | 3.3 | — | — |
| Control 1-X | RAIN-X control | 104.2 | 1.8 | — | — |
| RM-1 | RAIN-X/MP-55 52-48 after double lap | 136.7 | 6.6 | — | — |
| | shear testing 3 cycles | | | | |
| RM-2 | RAIN-X/MP-55 52-48 after double lap | 142.5 | 8.2 | — | — |
| | shear testing 3 cycles | | | | |
| RM-3 | RAIN-X/MP-55 52-48 after double lap | 136.9 | 12.0 | — | — |
| | shear testing 3 cycles | | | | |
| RM-7 | RAIN-X/MP-55 52-48 0 cycles | 143.3 | 10.9 | — | — |
| M4-2 | RAIN-X/MP-55 60-40 after double lap | 129.6 | 18.1 | — | — |
| | shear testing 4 cycles | | | | |
| M42-1 | RAIN-X/MP-55 60-40 after double lap | 130.3 | 18.3 | — | — |
| | shear testing 4 cycles | | | | |
| MT-4 | RAIN-X/MP-55/Tinuvin 400 55-37-8 | 94.1 | 8.4 | — | — |
| | after double lap shear testing 4 cycles | | | | |
| M4-3 | RAIN-X/MP-55 60-40 after double lap | 124.4 | 10.9 | — | — |
| | shear testing 4 cycles | | | | |
| M42-2 | RAIN-X/MP-55 60-40 | 128.2 | 20.4 | — | — |
| MT-5 | RAIN-X/MP-55/Tinuvin 400 55-37-8 | 100.4 | 11.9 | — | — |
| | after double lap shear testing 4 cycles | | | | |
| 401 | RAIN-X/MP-55 60-40 on KOROPON | 149.6 | 1.4 | 136.9 | 1.7 |
| 402 | RAIN-X/MP-55/DF1040 55-37-8 on | 148.9 | 2.8 | 144.2 | 2.1 |
| | KOROPON | | | | |
| 403 | RAIN-X/MP-55/DF1040 58-38-4 on | 150.8 | 1.2 | 137.1 | 6.9 |
| | KOROPON | | | | |
| 404 | RAIN-X/MP-55 60-40 on Kapton ® Tape | 148.4 | 2.5 | 141.4 | 3.1 |
| 405 | RAIN-X/MP-55 60-40 on Kapton ® Film | 146.6 | 4.5 | 131.9 | 8.7 |
| 406 | RAIN-X/MP-55/DF1040 55-37-8 on | 146.1 | 2.7 | 136.7 | 3.3 |
| | Kapton ® Film | | | | |

Table 10 herebelow provides contact angle data of various icephobic formulations showing surface energy interactions with water. Spray-On Foam Insulation (SOFI) used for the coupons and on the External Tank are closed cell polyurethane and polyisocyanurate foam materials. Coating formulations are made by weight percent addition of constituent materials as described in listed examples (i.e. RAIN-X/MP-55/Tinuvin 400 55-37-8 is 55% by weight RAIN-X, 37% by weight MP-55 PTFE powder, and 8% by weight Tinuvin 400 UV absorber).

TABLE 10

| Sample | | 0 days | |
|---|---|---|---|
| Foam | | Average | 0 days |
| Coupons | Description | (°) | SD (°) |
| S31 | SOFI control | 143.7 | 1.8 |
| S32 | RAIN-X/MP-55/Tinuvin 400 55-37-8 | 146.8 | 3.5 |
| S33 | RAIN-X/MP-55/Tinuvin 400 62-30-8 | 146.7 | 1.6 |
| S34 | RAIN-X/MP-55/Tinuvin 400 72-20-8 | 145.1 | 1.0 |
| S35 | RAIN-X/MP-55 60-40 | 140.7 | 1.4 |
| S36 | RAIN-X/MP-55 70-30 | 145.1 | 1.2 |
| S37 | RAIN-X/MP-55 80-20 | 147.3 | 0.5 |
| 11 | SOFI control | 129.7 | 3.0 |
| 12 | RAIN-X control | 140.9 | 2.5 |
| 13 | RAIN-X/MP-55 50-50 | 146.0 | 3.7 |
| 14 | RAIN-X/MP-55 50-50 | 144.3 | 3.1 |
| 15 | RAIN-X/MP-55/Tinuvin 400 46-46-8 | 145.4 | 2.3 |
| 16 | RAIN-X/MP-55/Tinuvin 400 46-46-8 | 147.2 | 1.6 |
| 17 | RAIN-X/UF-8TA 50-50 | 149.1 | 2.0 |
| 18 | RAIN-X/UF-8TA 50-50 | 149.0 | 2.4 |
| 19 | RAIN-X/UF-8TA/Tinuvin 400 46-46-8 | 147.3 | 3.0 |
| 21 | RAIN-X/MP-55 60-40 | 149.3 | 3.5 |
| 22 | RAIN-X/MP-55 70-30 | 150.5 | 2.2 |
| 23 | RAIN-X/MP-55 80-20 | 142.0 | 4.9 |
| 24 | RAIN-X/MP-55/Tinuvin 400 54-38-8 | 151.6 | 1.4 |
| 25 | RAIN-X/MP-55/Tinuvin 400 61-31-8 | 148.1 | 2.3 |
| 26 | RAIN-X/MP-55/Tinuvin 400 72-19-9 | 147.6 | 1.8 |
| 28 | SOFI control | 105.7 | 25.1 |
| 99 | RAIN-X/UF-8TA 43-57 | 137.3 | 10.1 |

Table 11 herebelow provides contact angle data of various icephobic formulations showing surface energy interactions with water. Coating formulations are made by weight percent addition of constituent materials as described in listed examples (i.e. RAIN-X/MP-55/Tinuvin 400 55-37-8 is 55% by weight RAIN-X, 37% by weight MP-55 PTFE powder, and 8% by weight Tinuvin 400 UV absorber). Samples 116 and 117 were made in the same manner as that described for Example 5 with the exception that RAIN-X and MP-55 were allowed to sit in a closed container for 2 hours before the addition of Tinuvin 400 and the substrate was SOFI not Koropon primer. The data show the resulting coatings to be super-hydrophobic and durable after weathering in the Kennedy Space Center launch pad environment.

TABLE 11

| | | | 0 | | 30 | 180 | 180 |
|---|---|---|---|---|---|---|---|
| Sample | | 0 days | days | 30 days | days | days | days |
| Foam | | Average | SD | Average | SD | Average | SD |
| Coupons | Description | (°) | (°) | (°) | (°) | (°) | (°) |
| 101 | SOFI control | 141.5 | 3.2 | 133.0 | 4.5 | — | — |
| 102 | RAIN-X control | 144.4 | 2.3 | 140.3 | 4.1 | — | — |
| 103 | RAIN-X/MP-55 60-40 | 147.4 | 1.2 | 139.4 | 4.2 | — | — |
| 104 | RAIN-X/MP-55/Tinuvin | 145.0 | 1.9 | 147.4 | 0.9 | — | — |
| | 400 55-37-8 | | | | | | |
| 105 | RAIN-X/MP-55/Tinuvin | 150.2 | 0.9 | 146.9 | 1.7 | — | — |
| | 400 58-38-4 | | | | | | |
| 106 | RAIN-X/MP-55/Tinuvin | 149.5 | 2.2 | 144.7 | 1.5 | — | — |
| | 400 59-39-2 | | | | | | |
| 107 | SOFI control | 136.7 | 3.2 | — | — | 107.4 | 18.2 |
| 108 | RAIN-X control | 145.1 | 2.5 | — | — | 126.1 | 4.8 |
| 109 | RAIN-X/MP-55 60-40 | 151.3 | 1.8 | — | — | 111.0 | 15.0 |
| 110 | RAIN-X/MP-55/Tinuvin | 147.6 | 2.5 | — | — | 142.5 | 1.2 |
| | 400 55-37-8 | | | | | | |
| 111 | RAIN-X/MP-55/Tinuvin | 148.5 | 1.3 | — | — | 122.3 | 10.2 |
| | 400 59-38-4 | | | | | | |
| 112 | RAIN-X/MP-55/Tinuvin | 149.3 | 1.7 | — | — | 121.2 | 10.6 |
| | 400 59-39-2 | | | | | | |
| 113 | SOFI control | 141.2 | 2.2 | 53.5 | 16.8 | — | — |
| 114 | RAIN-X/MP-55/Tinuvin | 145.5 | 1.3 | 137.2 | 4.7 | — | — |
| | 400 59.1-39.4-1.5 | | | | | | |
| 115 | RAIN-X/MP-55/Tinuvin | 147.8 | 2.9 | 137.4 | 4.7 | — | — |
| | 400 59.4-39.9-0.7 | | | | | | |
| 116 | RAIN-X/MP-55/Tinuvin | 147.8 | 2.2 | 129.6 | 5.6 | — | — |
| | 400 58.9-39.9-1.2 delay | | | | | | |
| 117 | RAIN-X/MP-55/Tinuvin | 147.9 | 2.4 | 141.2 | 2.7 | — | — |
| | 400 59.2-40.0-0.7 delay | | | | | | |
| 301 | RAIN-X/MP-55 60-40 | 149.5 | 0.8 | 134.7 | 4.4 | — | — |
| 302 | RAIN-X/MP-55/ | 146.7 | 2.2 | 134.3 | 3.6 | — | — |
| | DF1040 55-37-8 | | | | | | |
| 303 | RAIN-X/MP-55/ | 147.6 | 1.3 | 135.3 | 2.6 | — | — |
| | DF1040 58-38-4 | | | | | | |
| 304 | SOFI control | 139.9 | 2.6 | 87.9 | 34.9 | — | — |

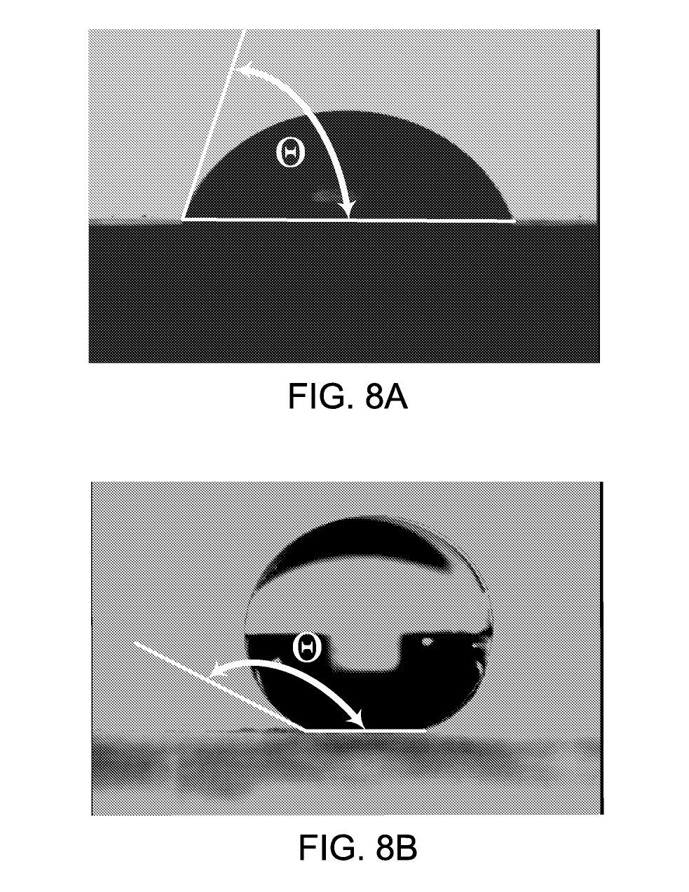

Contact angle data concur with the XPS results indicating that the applied hydrophobic coating remains present on the tested coupon surfaces, and indicate that the hydrophobic performance of the untested surface is largely preserved after three test cycles. FIG. 8A depicts an example of a contact angle of a water droplet on a KOROPON-surfaced control coupon and having a contact angle Θ of approximately 73° while FIG. 8B depicts an example of a contact angle of a water droplet on a KOROPON-surfaced coupon having a coating in accordance with an embodiment of the invention and having a contact angle Θ of approximately 152°.

Scanning electron microscopy (SEM) coupled with an energy dispersive spectroscopy (EDS) elemental map of fluorine was used to visualize conditions on coupon surfaces coated with a composition in accordance with an embodiment of the invention. A test coupon was thinly coated and left to cure for more than 2 days prior to analysis, abrasive wiping, and re-analysis. SEM analysis indicated that abrasive wipe did not remove all PTFE from the surface of the sample. The diameters of the MP-55 beads, measured by the SEM, fell below the wavelength of visible light. This result infers that, even when it may appear that the coating has been removed, it actually remains present. These SEM results verifying the presence of MP-55 on the coupon surface following abrasion support those of the XPS and contact angle analyses of tested coupons.

Although the aforementioned testing utilized a gloved finger to apply the compositions to the test surfaces, other application techniques are suitable. For example, the compositions may be sprayed, brushed, or rolled onto a surface. Commonly available foam paint brushes, i.e., a tapered foam pad on a wooden handle, were found to produce a thick and uniform coating with some streaking. Note that streaking is not a concern to the functionality of the compositions.

The compositions in accordance with embodiments of the invention can range from pastes to fluids suitable for use in common industrial spray equipment, depending upon the level of solids. For example, a composition containing approximately 40% PTFE would generally be in a paste form while a composition containing approximately 20% PTFE would be sufficiently liquid as to be suitable for spraying. Various embodiments can range from approximately 5% fluoropolymer resin to approximately 60% fluoropolymer resin. Such embodiments would contain from approximately 9% siloxanes to approximately 4% siloxanes, respectively, with the remainder being essentially a carrier solvent. As an example, one embodiment may be formulated using approximately 95% RAIN-X solution and 5% MP-55 PTFE powder, another embodiment may be formulated using approximately 80% RAIN-X solution and 20% MP-55 PTFE powder, another embodiment may be formulated using approximately 60% RAIN-X solution and 40% MP-55 PTFE powder, and another embodiment may be formulated using approximately 40% RAIN-X solution and 60% MP-55 PTFE powder. Each of the preceding examples may further include a UV light absorber.

The fluoropolymer resin should include fine particles. The various embodiments may include particles of less than 1 mm, preferably having an average particle size less than about 200 μm, more preferably having an average particle size of approximately 4 μm. For at least some embodiments, a minimum particle size of the fluoropolymer resin may be 200 nm or less.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed is:

1. A composition for ice adhesion mitigation, comprising:
40-95 wt % of a dilute solution of poly alkyl hydrogen siloxanes in an acidified alcohol carrier; and
5-60 wt % of fluoropolymer resin particles having a particle size of less than 1 mm.

2. The composition of claim 1, wherein the fluoropolymer resin particles comprise a polytetrafluoroethylene powder.

3. The composition of claim 1, wherein the fluoropolymer resin particles comprise a mixture of polytetrafluoroethylene powders.

4. The composition of claim 2, wherein the polytetrafluoroethylene powder has an average particle size of approximately 4.0 μm and a minimum particle size of approximately 0.2 μm.

5. The composition of claim 4, wherein the polytetrafluoroethylene powder comprises a density of approximately 300 g/L.

6. The composition of claim 1, wherein the dilute solution of poly alkyl hydrogen siloxanes in an acidified alcohol carrier comprises approximately 5% poly alkyl hydrogen siloxanes.

7. The composition of claim 1, wherein the dilute solution of poly alkyl hydrogen siloxanes in an acidified alcohol carrier comprises:
approximately 86% ethanol/SD alcohol 40;
approximately 4% isopropanol;
approximately 1% ethyl sulfate;
less than 9% polydimethylsiloxanes;
less than 9% silicic acid, tetraethyl ester, hydrolysis products with chlorotrimethylsilane; and
less than 9% siloxanes and silicones, di-Me, hydroxy-terminated.

8. The composition of claim 1, further comprising approximately 0.1-20 wt % of an ultraviolet light absorber.

9. The composition of claim 1, further comprising approximately 0.1% to 20% polymethyl hydrosiloxane fluid

10. A composition for ice adhesion mitigation, comprising:
60-80 wt % of a dilute solution of poly alkyl hydrogen siloxanes in an acidified alcohol carrier; and
20-40 wt % of polytetrafluoroethylene resin particles having an average particle size of approximately 4 μm.

11. The composition of claim 10, wherein the polytetrafluoroethylene resin particles have a minimum particle size of approximately 0.2 μm.

12. The composition of claim 11, wherein the polytetrafluoroethylene resin particles comprise a density of approximately 300 g/L.

13. The composition of claim 10, wherein the dilute solution of poly alkyl hydrogen siloxanes in an acidified alcohol carrier comprises approximately 5% poly alkyl hydrogen siloxanes.

14. The composition of claim 10, wherein the dilute solution of poly alkyl hydrogen siloxanes in an acidified alcohol carrier comprises:
approximately 86% ethanol/SD alcohol 40;
approximately 4% isopropanol;
approximately 1% ethyl sulfate;
less than 9% polydimethylsiloxanes;
less than 9% silicic acid, tetraethyl ester, hydrolysis products with chlorotrimethylsilane; and
less than 9% siloxanes and silicones, di-Me, hydroxy-terminated.

15. The composition of claim 10, further comprising approximately 0.1-20 wt % of an ultraviolet light absorber.

16. A method of treating a surface, comprising:
applying a composition to the surface comprising 40-95 wt % of a dilute solution of poly alkyl hydrogen siloxanes in an acidified alcohol carrier and 5-60 wt % of fluoropolymer resin particles having a particle size of less than 1 mm.

17. The method of claim 16, further comprising:
allowing the composition to dry; and
buffing or brushing the surface after the composition has dried.

18. The method of claim 16, wherein applying the composition to the surface comprises brushing the composition onto the surface or spraying the composition onto the surface.

19. The method of claim 16, wherein applying a composition to the surface comprising 40-95 wt % of a dilute solution of poly alkyl hydrogen siloxanes in an acidified alcohol carrier and 5-60 wt % of fluoropolymer resin particles having a particle size of less than 1 mm comprises applying a composition to the surface comprising 60-80 wt % of the dilute solution of poly alkyl hydrogen siloxanes in an acidified alcohol carrier and 20-40 wt % of the fluoropolymer resin particles.

20. The method of claim 19, wherein applying a composition to the surface comprising 5-60 wt % of fluoropolymer resin particles comprises applying a composition to the surface comprising polytetrafluoroethylene resin particles having an average particle size of approximately 4.0 μm and a minimum particle size of approximately 0.2 μm.

21. The method of claim 20, wherein applying a composition to the surface comprising 5-60 wt % of fluoropolymer resin particles comprises applying a composition to the surface comprising 5-60 wt % of polytetrafluoroethylene resin particles further having a density of approximately 300 g/L.

22. The method of claim 16, wherein applying a composition to the surface comprising 40-95 wt % of a dilute solution of poly alkyl hydrogen siloxanes in an acidified alcohol carrier comprises applying a composition to the surface comprising a solution containing approximately 5% poly alkyl hydrogen siloxanes.

23. The method of claim 16, wherein applying a composition to the surface comprising 40-95 wt % of a dilute solution of poly alkyl hydrogen siloxanes in an acidified alcohol carrier comprises applying a composition to the surface comprising a solution of poly alkyl hydrogen siloxanes comprising:
approximately 86% ethanol/SD alcohol 40;
approximately 4% isopropanol;
approximately 1% ethyl sulfate;
less than 9% polydimethylsiloxanes;
less than 9% silicic acid, tetraethyl ester, hydrolysis products with chlorotrimethylsilane; and
less than 9% siloxanes and silicones, di-Me, hydroxy-terminated.

24. The method of claim 16, wherein applying a composition to the surface comprising 40-95 wt % of a dilute solution of poly alkyl hydrogen siloxanes in an acidified alcohol carrier and 5-60 wt % of fluoropolymer resin particles having a particle size of less than 1 mm comprises applying a composition to the surface comprising 40-95 wt % of the dilute solution of poly alkyl hydrogen siloxanes in an acidified alcohol carrier, 5-60 wt % of the fluoropolymer resin particles and approximately 0.1-20 wt % of an ultraviolet light absorber.

25. A composition for ice adhesion mitigation, comprising:
a dilute solution of poly alkyl hydrogen siloxanes in an acidified alcohol carrier; and
fluoropolymer resin particles having a particle size of less than 1 mm.

26. The composition of claim 25, wherein the fluoropolymer resin particles are approximately 5-60 wt % and comprise a polytetrafluoroethylene powder.

27. The composition of claim 25, wherein the dilute solution of poly alkyl hydrogen siloxanes in an acidified alcohol carrier are approximately 40-95 wt % and comprises approximately 5% poly alkyl hydrogen siloxanes.
